(19) United States
(12) Patent Application Publication
(10) Pub. No.: US 2012/0044255 A1
(43) Pub. Date: Feb. 23, 2012

(54) INTELLIGENT DISPLAY

(76) Inventors: Baldave Singh, Glasgow (GB); Bhupinder Seran, Glasgow (GB)

(21) Appl. No.: 13/266,234

(22) PCT Filed: Apr. 27, 2010
(86) PCT No.: PCT/GB2010/050685

§ 371 Date: Oct. 25, 2011

(30) Foreign Application Priority Data
Apr. 28, 2009 (GB) 0907270.3

(51) Int. Cl. G06F 3/01; G09G 5/02; G06F 3/033

(52) U.S. Cl. 345/594; 345/156; 345/161

(57) ABSTRACT

An LED display device which comprises a display for displaying images stored in device memory and may be used to construct and store images, and edit images, using an input device integral to the display device such that it is operable as a self contained and stand-alone device. The display device is also connectable to like display devices to provide larger display areas. The LED display device may optionally also function as a gaming device.

### FIELD OF INVENTION

The present invention relates to a display device, and particularly to a self contained stand-alone display device capable of editing display images.

### BACKGROUND

LED displays, whether used in signage or advertising, such as one may observe in shop-front displays or at sporting events such as televised football matches, are normally driven by a computer or some remote console. The content is always edited on a computer, or some video source is used to stream images to the display. The data is normally sent out to drive electronics which route the various image segments to the appropriate portions of the display.

The amount of intelligence or autonomy provided is normally no greater than that required to display data previously stored in volatile or non-volatile memory. By providing a processor the data received earlier can be displayed continuously in the absence of provision of new data. In digital or LED signage the data displayed is previously stored or updated through a remote or detached controller which may be temporarily attached to transfer new content. Data retention and display is the extent of autonomy provided on these displays.

### SUMMARY OF INVENTION

According to a first aspect of the present invention there is provided a display system comprising at least one display, the at least one display having at least one interconnect for connecting the display to at least one further display to form an interconnected display.

The at least one display may be disconnectably connectable to at least one further display.

The interconnect may be a wired or a wireless interconnect. The display may be arranged to connect directly to another display. The display may be arranged to connect to another display via a connecting device. The display may be arranged to connect to another display via a serial input/output connector, a parallel connector, USB, IR, RF and/or firewire interconnectors.

Each display may be operable as a stand alone unit.

The two or more displays may be arranged to abut one another. The two or more displays may be arranged to connect such that the interconnected display formed thereby is operable as a unitary display.

Each display may have a displayable area capable of displaying one or more images. The displayable area of each display may extend to at least one edge or peripheral portion of the display and/or extend over substantially a whole surface of the display. In this way, two or more displays may be connectable, preferably disconnectably connectable, to form a substantially seamless interconnected display. The abutting edges or peripheral portions may be linear. The display may be quadrilaterally shaped, such as rectangularly shaped or square.

Each display may be shaped to form a recess for accommodating at least one part of the display that projects beyond the display area. Two or more displays may be connectable together to form a substantially seamless interconnected display.

The display may comprise a matrix or array of display pixels. The display pixels may be arranged in at least one row and/or at least one column, for example, in rows and columns. Each display pixel may be individually addressable. At least one pixel may abut at least one other pixel. The display pixels in each row may be linked by one or more row connectors and/or the display pixels in each column may be linked by one or more column connectors. Each display pixel may be addressable by providing a signal to one or more corresponding row and/or column connectors. The display may address display pixels by applying a swept signal to successive row connectors whilst selectively applying signals to column connectors in order to address individual display pixels in each swept row. The display may address display pixels by applying a swept signal to successive column connectors whilst selectively applying signals to row connectors in order to address individual display pixels in each swept column.

The display may comprise an input means adapted to select one or both of a background colour and a foreground colour of a character or image. The input means may comprise a switch, push button or the like. Preferably, repeated actuation of the input means permits selection of said colours by cycling through a palette of colours.

Each display pixel may comprise one or more display means. Each display pixel may comprise two or more display means, such as three, four or five display means.

Each display means may comprise an LED. Each display means may be arranged to provide a variable light intensity. Each display means associated with a display pixel may be adapted to produce a different colour.

According to a second aspect of the present invention there is provided a display system comprising at least one display, wherein the at least one display comprises a processor for controlling the display and a memory for storing at least one image for the display.

The at least one display may comprise at least one interconnector for connecting to at least one other display. The two or more displays may be connectable together to form an interconnected display. The interconnected displays may cooperate via the at least one system interconnectors in order to function as a unified display.

The display system and/or one or more displays may further comprise input means for receiving input.

The one or more displays and/or the display system may be a unitary and/or self contained device.

The display system may be a display system according to the first aspect.

The display system may take the form of an intelligent tile. An intelligent tile is a display system that is provided with it's own processor and memory means, which may allow it to independently perform so called smart features, for example, image processing, programming and editing, yet may be provided with interconnect and cooperative features to allow each intelligent tile to be connected with at least one other intelligent tile and/or a master controller in order to form an integrated display system, such that each tile may be operable as a stand alone unit and/or as part of a larger integrated system with at least one other intelligent tile and/or a master controller.

The display may comprise a matrix or array of display pixels. The display pixels may be arranged in at least one row and/or at least one column, for example, the display pixels may be arranged in rows and columns. Each display pixel may be individually addressable. The display pixels in each row may be linked by one or more row connectors and/or the display pixels in each column may be linked by one or more column connectors. Each display pixel may be addressable by providing a signal to one or more corresponding row and/or column connectors. The display may address display pixels by applying a swept signal to successive row connectors whilst selectively applying signals to column connectors in order to address individual display pixels in each swept row. The display may address display pixels by applying a swept signal to successive column connectors whilst selectively applying signals to row connectors in order to address individual display pixels in each swept column.

Each display pixel may comprise one or more display means. Each display pixel may comprise two or more display means, such as three, four or five display means.

Each display means may comprise an LED. Each display means may be arranged to provide a variable light intensity. Each display means associated with a display pixel may be adapted to produce a different colour.

Two or more displays may be arrangeable together to form selectable interconnected display area configurations, which may include a rectangular display area configuration, a square display area configuration and/or a generally circular or oval display area configuration.

The display systems may be connectable together so as to form a substantially seamless display. A display of each display system may extend to at least one edge or peripheral portion of the display system and/or extend over substantially a whole surface of the display system. In this way, two or more display systems may be connectable, preferably disconnectably connectable, to form a substantially seamless interconnected display. Abutting edges or peripheral portions of the display systems may be linear. The display system may be quadrilaterally shaped, such as rectangularly shaped or square.

The input means may comprise one or more keys and/or switches. The input means may comprise, or may comprise an interface for receiving a signal from, a gamepad, joystick, a wireless controller such as a radio, RF or IR controller, a trackball, a mouse and/or a keyboard.

The memory may comprise ROM and/or RAM and/or EEPROM and/or other suitable memory means. The memory may comprise a computer readable medium, which may comprise a memory card such as a flash memory card, CD or DVD ROM, or any means or device for reading or receiving input from such a computer readable medium.

The memory may be arranged to store at least one image for the display. The image may be stored on a pixel by pixel basis. The memory may be arranged to store a plurality of images for the display. The processor may be operable to sequentially display at least two images in order to display an animation.

The display system and/or at least one display may be provided with an editing module, which may be for editing the at least one image. The editing module may be implemented in any way known in the art, such as comprising at least part of a computer program stored in the memory and implemented using the processor and/or a portion of the processor and/or a separate hardware component, processing means or the like.

The editing module may be arranged to read and/or display the at least one image from the memory, and/or receive input from the input means and may update the at least one image responsive to the input received from the input means. The editing module may be arranged to provide editing of the at least one image on a pixel by pixel basis. The editing module may be arranged to alter a display intensity and/or colour associated with pixels of the image. The editing module may be arranged to display the edited image on the display and/or store the edited image in the memory. The editing module may be operable to retrieve two or more images and superimpose at least part of one image onto at least one other image. At least one of the two or more retrieved images may be retrieved from a computer readable medium. An image may comprise a picture and/or an animation and/or text and/or characters.

The display system may be operable as an electronic sign. The display system may be operable as a games unit.

According to a third aspect of the present invention there is provided a games unit comprising at least one display system according to the first and/or second aspects.

The at least one display system may comprise a plurality of displays interconnected so as to form an interconnected display. The interconnected display may be operable as a unitary display and/or a multi-display system and/or provide a substantially seamless display area.

The games unit may comprise a master controller. The master controller may be in communication with at least one display system and/or display. The master controller may be arranged to coordinate and/or control at least one display system and/or display processor in order to operate the at least one display system as part of an interconnected display and/or implement a program and/or game.

The games unit may be arranged to display substantially the whole of a game area on a display of a display system and/or the interconnected display. The games unit may be provided with input means arranged to receive input from a plurality of input devices, such as ten or more and preferably 14 or more input devices.

The display may be arranged to display a bird's eye view of the game area.

The device may be arranged to provide a sports game, such as a football (soccer), cricket, American football or hockey game.

A plurality of display systems may be connectable together to form an interconnected display of the display system having a predetermined shape and/or size, which may be shaped and/or sized to suit the game area. For example, a football game may require a rectangular interconnected display, whilst a cricket game may require a more rounded interconnected display, although other sizes and/or shapes of display area may be achievable depending on the requirements of the application.

The processor may be arranged to display at least one player in the game area. Each player may be controllable responsive to the input of at least one input means.

The processor may be arranged to implement collision control, arranged to determine when at least two game objects collide and/or when at least two objects pass. In this way, it can be determined when a ball of a game interacts with a player or the ball passes by the player, for example if the ball is determined to be in the air above the player.

According to a fourth aspect of the present invention there is provided an interface comprising a plurality of display areas, arranged to cooperate to display a corresponding plurality and preferably substantially a whole of an application and/or game area.

In this way, the whole application or game display may be displayed in one interface and may minimise or negate the need for scrolling, windowing, or cycling between screens.

The interface may be a man-machine interface.

An application or game area is defined as a total area that may be viewed as part of an application or game. For example, in a soccer game, the game area may comprise the whole of the soccer pitch.

Each display area may correspond to an interconnectable or interconnected display. The display may belong to a display of the first aspect or a display system of the second aspect.

### BRIEF DESCRIPTION OF DRAWINGS

Various embodiments of the invention will now be described by way of example only and with reference to the accompanying drawings which are:

FIG. 1: a circuit diagram of a display system;

FIG. 2: a top view of a display system using the circuit of FIG. 1;

FIG. 3: a sectional view of the display system of FIG. 2;

FIG. 4: a side view of the display system of FIG. 2 from a first side;

FIG. 5: a side view of the display system of FIG. 2 from a second side;

FIG. 6: a top view of a display system using the circuit of FIG. 1, and arranged to operate as a games unit;

FIG. 7: a sectional view of the display system of FIG. 6;

FIG. 8: a side view of the display system of FIG. 6 from a first side;

FIG. 9: a side view of the display system of FIG. 6 from a second side;

FIG. 10(a) and FIG. 10(b): a perspective view of two display systems of FIG. 6 or FIG. 2 in separate and interconnected configurations;

FIGS. 11(a) to 11(b): examples of interconnected display configurations; and

FIG. 12: an input interpretation system for use by the display system of FIG. 1.

### SPECIFIC DESCRIPTION

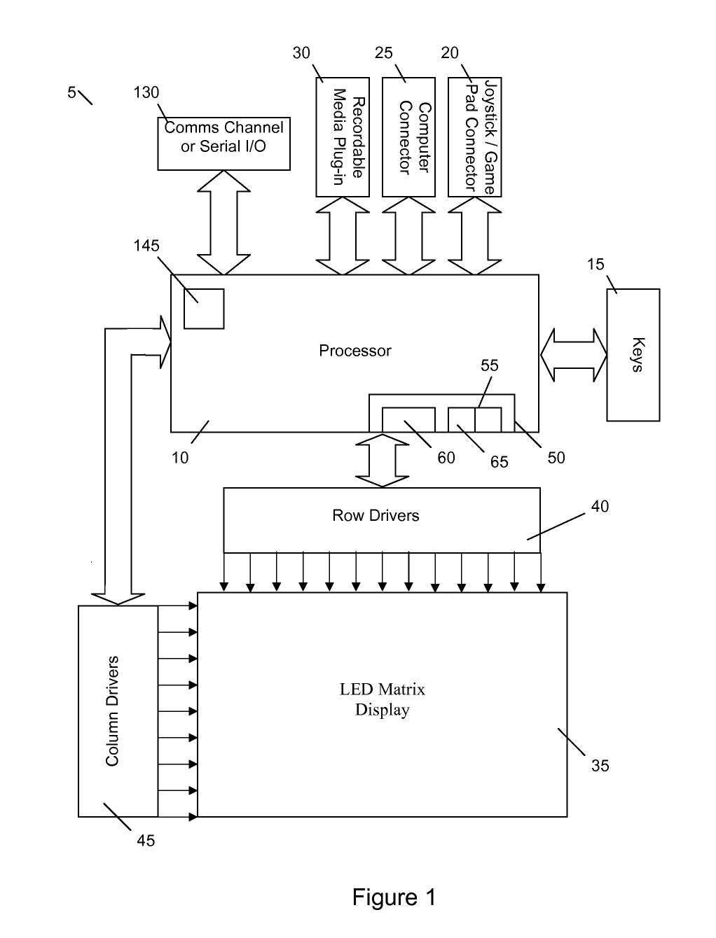

FIG. 1 shows a circuit diagram of a display system 5 according to the present invention, which is operable as an intelligent display tile. An intelligent tile is a display system that may independently perform so called smart features, for example, image processing, programming and editing, yet may be provided with interconnect and cooperative features to allow each intelligent tile to be connected with at least one other intelligent tile and/or a master controller in order to form an integrated display system, such that it each tile may be operable both as a stand alone unit or as part of a larger integrated system with at least one other intelligent tile and/or a master controller.

The intelligent display tile is provided with a processor and memory and may be interconnectable with other intelligent display tiles in order to provide an adaptable and customisable display that is capable of being rearranged into a wide range of configurations and carrying out a wide range of functions. This allows the intelligent display tile to be used in a variety of applications, for example, a sign or display, a toy, an entertainment device, or as a games unit.

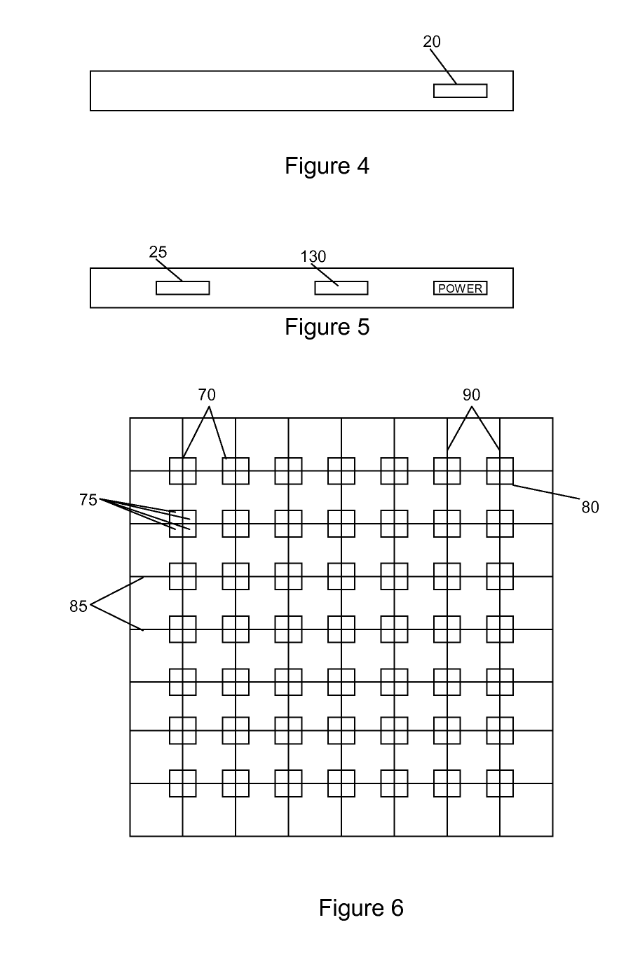

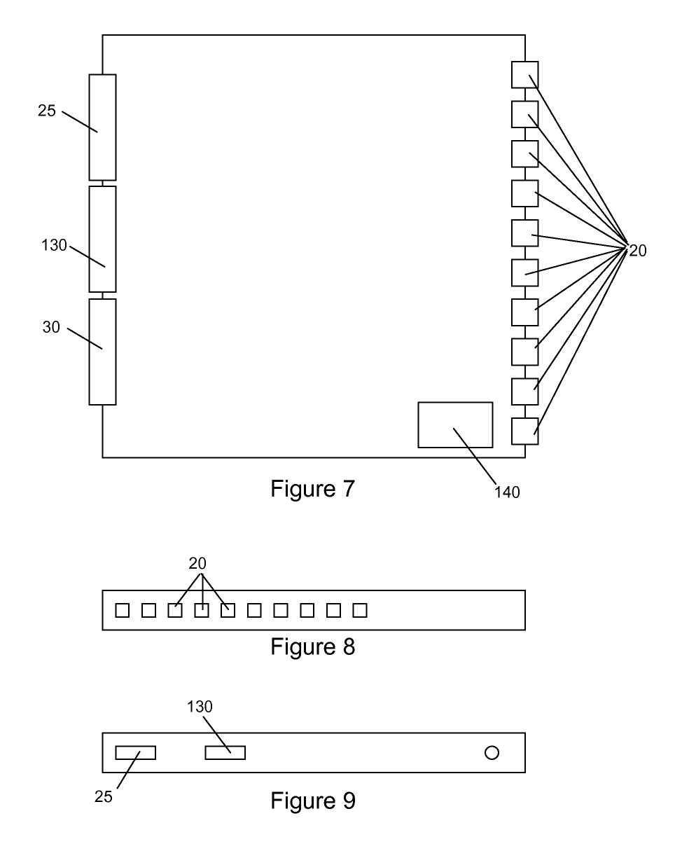

As shown in FIGS. 1 to 9, the display system 5 comprises a processor 10 coupled with a keypad 15; a connector 20 for connecting a game controller, such as a joystick or game pad; an interface 25, such as a USB port or the like, for connecting to a personal computer and a memory card reader 30. The interface 25, connectors 20 and reader 30 are provided with peripheral controllers and/or other means arranged to implement connection of devices. The display system 5 further comprises a display 35 coupled to the processor 10 via a row driver 40 and a column driver 45.

The processor 10 is provided with memory 50 in the form of on-board RAM 55 and EEPROM 60. The on-board RAM 55 includes a display memory 65 for storing data for displaying images on the display 35. The EEPROM 60 is arranged to store program modules for operating the processor 10 and thereby the display system 5.

The display 35 comprises a matrix of LED clusters 70. Each LED cluster 70 comprises four LEDs 75 of varying colours, so that each cluster 70 effectively forms a pixel 80 of the display 35. Although in this embodiment, each cluster 70 comprises four LEDs 75, it will be appreciated that each cluster 70 may instead comprise other LED configurations, such as one, two, three or five LEDs. For example, the LEDs may be arranged as a red/blue/green (RGB) cluster.

The clusters 70 are interconnected in rows and columns, joined by row connectors 85 and column connectors 90 respectively to the row driver 40 and the column driver 45. The row 40 and column 45 drivers are operable to apply signals to the row and column connectors 85, 90 so as to selectively activate selected LEDs 75 within a selected cluster 70. The display 35 is provided with a black background layer 95 in order to provide a contrast with illuminated LEDs 75.

Selection of which LEDs 75 within a cluster 70 to illuminate and the intensity at which to light the LEDs 75 is determined by the signal applied via the row and column drivers 40, 45. In this way, the colour, brightness and appearance of the illuminated cluster 70 may be controlled by the processor 10.

The row and column drivers 40, 45 are controllable by the processor 10 responsive to instructions from operating programs stored in the memory 50 and/or input received from users via the keypad 15 and/or game pads via the connector 20.

The display 35 is continually refreshed by the processor 10 to display an image as stored in the display memory 65. Four or more bits of display memory 65 are allocated per LED 75. In this example, twelve bits of display memory 65 are allocated per LED 75. This gives a greyscale value of 4096 per LED 75, which has been found may give an acceptable display performance. This configuration may provide a possibility of 10⁹ colours for each LED cluster 70. The amount of display memory 65 allocated to an image depends on the size (i.e. the number of pixels 80 and number of LEDs 75) of the display 35.

The keypad 15 comprises a plurality of keys 100-125, which may be arranged to suit the application for which the display system 5 is being used. For example, if the display system 5 is to be used as a sign or display board, then nine keys may be provided, including four direction keys 100, a record key 105, a colour change key 110, an advance key 115, an animate key 120 and a delete key 125.

The display system 5 is provided with an interconnector 130 for connecting to other display systems. In this embodiment, the interconnector 130 comprises a serial input/output connector. However, a skilled person would realise that it would also be possible to use other wired or wireless interconnector types, such as parallel, USB, IR, RF or firewire connectors.

The interconnector 130 is coupled with the processor 10, such that when the display system 5 is connected to another display system via the interconnector 130, then the processors 10 of each display system 5 are permitted to communicate with each other via the interconnectors 130. In this way the processors 10 are operable under the control of software programmed into the EEPROM 60 or other memory 55 or provided on a memory card via the memory card reader 30 to communicate display data between each other. By interconnecting the displays 5 via the interconnector 130 and providing communication of display data between the processors 10 of each of the display systems 5, then the displays 35 of each display system 5 may operate together so as to act as a unitary display 135.

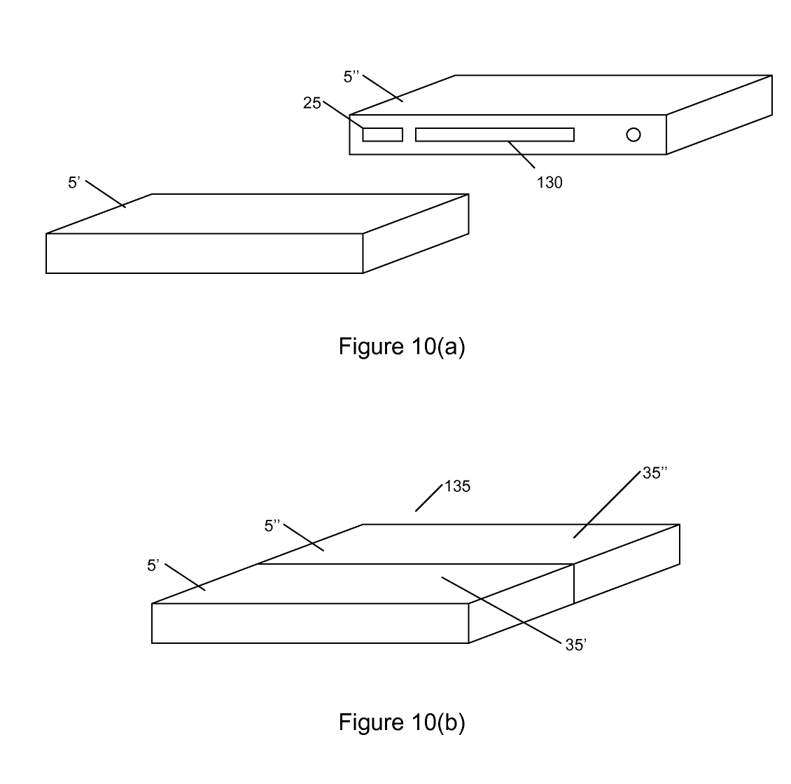

FIG. 10(a) shows two separate display systems 5′ and 5″ and FIG. 10(b) shows the two systems 5′, 5″ connected together via respective interconnectors 130 to form a unitary display. Each display system 5, 5′ is provided with additional attaching means for releasably attaching the displays 5′, 5″ together. Each of the display systems 5′, 5″ is quadrilaterally shaped and arranged so that at least one edge of each display system 5′ can snugly abut a complimentary edge of another display system 5″ so that the two display systems 5′, 5″ can connect together to form a substantially seamless interconnected display system.

For example, when two display systems 5′, 5″ are interconnected and are located adjacent and abutting each other and used as a game unit, an image of a football player displayed on a display 35 of a first display system 5 may kick an image representing a football. The image of the moving football may then be shown on the display 35 of the first display system 5 until it reaches a periphery of the display 35 adjacent the second display system. A master controller 140 is operable to coordinate the display systems and is in communication with both the first and second displays. The master controller is operable to determine and store object information and send the object information for the football, including its position, direction and speed to the processor of the second display unit. The second display system then shows the football on its display at a position on its periphery adjacent the last point at which it was shown on the display 35 of the first display system 5, and moving with the same trajectory and velocity and having the same appearance. In this way, the motion of objects, such as the ball, moving between display systems or objects displayed over multiple display systems appear seamless to users observing the interconnected display systems. This may allow a much larger game area to be displayed, which may advantageously allow a whole game area to be displayed at once and/or a much larger unitary display to be provided.

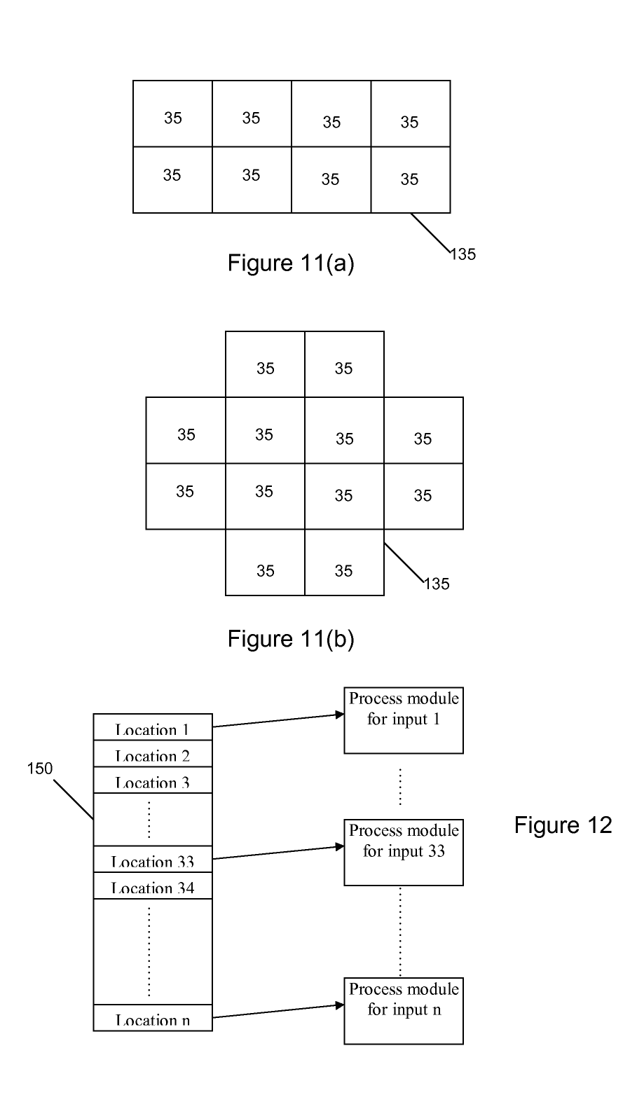

In optional embodiments, each display system 5, 5′, 5″ is provided with a plurality of interconnectors 130. The interconnectors 130 may be arranged on differing sides of the display. In this way, a plurality of display systems may be interconnected together in varying arrangements depending on which interconnector 130 is used. The unitary display 135 so formed may be of user selectable shape and size. For example, the unitary display 135 may be formed to be a rectangle, as shown in FIG. 11(a), square or generally circular, as shown in FIG. 11(b), depending on the requirements of the application for which it is to be used.

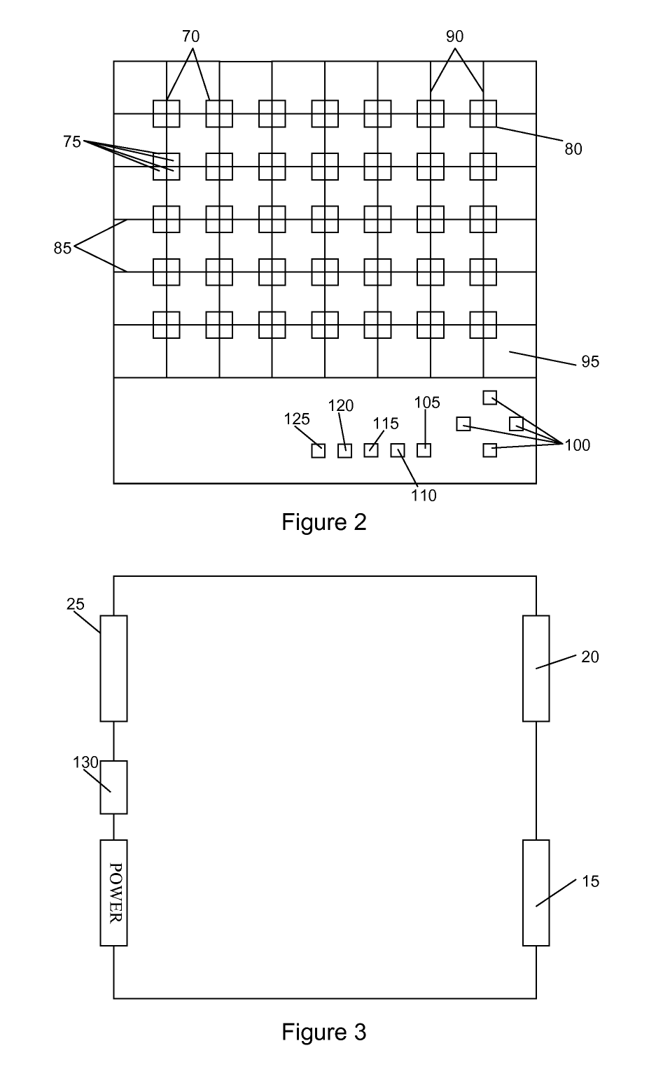

The display 35 may be arranged to extend to at least part of a perimeter edge of the display systems 5. For example, as shown in FIG. 2, the display 35 may extend to three edges, which may allow seamless connection of display systems 5 along three sides. As shown in FIG. 6, the display 35 may extend to four edges such that substantially a whole surface of the display system 5 is covered by the display 35. In this way, display systems 5 may be connected along any edge in order to form a wide variety of substantially seamless display configurations 135.

As an example of a use for the display system 5 is as an entertainment device or as a sign or shop display. In this embodiment, one or more display systems 5 may be used. The interconnectability of the display systems 5 may be used to create a unitary display 135 having a selected shape or size to suit a required purpose, for example to fit a shop window. However, the system is also operable as a single display unit, providing a relatively uncomplicated but intelligent and adaptable entertainment device.

The display memory 55 of the display system or systems 5 or a recordable medium is arranged to hold one or more images for provision to the display 35 of each display system 5. An image may consist of a single frame, or a plurality of frames arranged to form an animation.

The display system 5 is provided with an editing module 145, which is arranged to determine input made by the user using the keypad 15 and/or input device, such as a joystick or game pad, to provide an image to the display 35 and read and store images from the memory or computer readable medium. The editing module 145 may be implemented in various forms, as would be understood by a person skilled in the art, for example, as a stand alone hardware unit associated with the processor 10 or a functional module implemented by a computer program running in conjunction with the processor 10.

The editing module 145 is arranged to determine and display a cursor at a cursor position on the displayed image. The editing module 145 is operable to move the cursor position responsive to input provided by the user using the input means and/or direction keys 100 on the keypad 15. The editing module 145 is also operable to cycle through a range of colours upon operation of a colour change key 110 by the user by selectively illuminating and altering the intensity of the LEDs 75 of varying colour associated with the pixel point 80 of the display 35 used to display the cursor position. Once the user is happy with the colour and intensity of the pixel 80 in the image, the editing module 145 is operable to record the selected colour and intensity for that pixel 80 in the image as stored in the memory 50 or computer readable medium upon operation of a record key 105 by the user. Once editing of the image is complete, the editing module 145 is operable to move onto a next image responsive to operation of a frame advance key 115 by the user. A delete function is also provided by the editing module 145, responsive to operation of a delete key 125 by the user. The delete function sets the illumination of the LEDs 75 associated with a point in the currently displayed image corresponding to the current cursor point to zero.

In an optional embodiment the editing module may employ a pixel palette whereby, in the instance of displaying characters (for example, text or numeric characters or symbols), the character background or foreground colours may be selected in accordance with a displayed palette colour. The pixel palette colours may be cycled through by means of a switch, push button or the like, and the desired colour selected by means of the same or another switch, push button or the like.

The pixel palette may be extended to a strip pixel palette, whereby a number of contiguous pixels form a pixel strip in a row or column. The strip pixel palette can be cycled through via a switch (or the like) until the desired pixel strip is displayed. The same or another switch (or the like) may be used to select the desired pixel strip for the character foreground and background.

The display 35 is operable to display an animation responsive to a user operating an animate key 120. Upon the operation of the animate key 120, the processor 10 is operable to retrieve images from the memory 50 or computer readable medium and operate the row and column controllers 40, 45 of the display 35 so as to sequentially show the images on the display 35, so as to provide an animated display.

In optional embodiments, the editing module 145 is operable to construct pictures and animations using a compositing module. The compositing module is arranged to receive effects modules from the memory 50 or from a computer readable medium 25 and superimposed the effects modules onto still images. For example, an effects module may be arranged to provide a rainfall effect or a sunshine effect. The compositing module is arranged to superimpose the output of one or more effects module onto an image in any time related order and for selected time, in order to form a time multiplexed animation. Selection of the effects module and the order and duration of each effects module is selectable by the user using input devices 15, 20. In this way, an improved input system is provided whereby the user can quickly and easily create complex animations and visual effects with only limited input devices and in reduced time compared with full frame by frame editing. The effects modules may be part of a library or previously created by the user and stored on a computer readable medium or pre-stored in the memory.

In optional embodiments, the editing module 145 is adapted to facilitate reordering of images. For example, if an animation comprises four images, then the editing module may be programmable to show the images in the order: image 1-image 2-image 1-image 2-image 3-image 4-image 2-image 1 instead of simply image 1-image 2-image 3-image 4.

The display system 5 may be provided with a timer for timing the time that each image is displayed for. The editing module 145 may be arranged such that a delay between each frame is variable, to customise the speed of the animation.

As another example of an application of the above display systems 5, the use of display systems 5 as a game unit is now described.

The conformability and scalability of the display systems 5 allows the display systems 5 to be used to provide a real time simulated sports game unit. As described above, several display systems 5 may be connected together to form a large unitary interconnected display 135.

The master controller 140, for coordinating the display systems 5 is provided. In optional embodiments, the master controller 140 may be embedded in, or separate from and in communication with, at least one display system 5. In an optional embodiment, the processor 10 of at least one display system 5 may be operable to act as a master controller 140. An interconnector 130 of at least one display is usable to connect the displays to a master controller (not shown). Each display system 5 may be connected to the master controller 140 either directly or indirectly, for example by daisy chaining. The processors 10 of the display systems 5 cooperate together via the interconnectors 130 on each display system 5, along with the master controller 140, in order to control the game. The game software may be pre-stored in the EEPROM 60 of the display systems 5 and/or memory in the master controller 140 and/or provided upon a computer readable medium, such as via the memory card. The display systems 5 may be operable to share functional modules of the controlling program via the interconnectors 130. Each processor 10 is responsible for control of the functions of its associated display 35. Distributing control of each display system 5 to each display processor 10 may reduce the processing burden on the master controller 140.

The processors 10 and master controller 140 are operable, in conjunction with the game program, to control the gameplay aspects, detect collision of players and collisions of objects such as a ball with other players and/or objects. The processors 10 are also operable to simulate correct movement and direction of objects and players and in conjunction with the memory, determine features such as ball height, wherein a ball may bypass a player if a ball height is determined to be greater than a pre-determined value.

The processors 10 and master controller 140 are operable, in conjunction with the game program, to display an entire game area, such as a football or cricket pitch, on the unitary display as a bird's eye or aerial view.

A plurality of input devices such as gamepads or joysticks is provided. In one example, the input devices are provided on, or connectable to, the master controller, however, it will be appreciated that the input devices may also be provided on, or connectable to the display systems 5. In one example, fourteen gamepad or joystick inputs 20 are provided. This allows, for example, a game of seven a side football to be provided wherein each user has control of one player. The gamepad or joystick may provide an input in 8 bit or 6 bit digital format. The memory 50 is provided with a look-up-table 150. The look up table has from 1 to n memory positions, each memory position corresponding to an input or combination of inputs from the joysticks and/or gamepads and storing a maps for the input or combination of inputs to an action, such as operation of a process or functional module of the processor 10 and/or software, as shown in FIG. 12. In this way, the input from the controller may be quickly determined and implemented. The speed of this process is especially important in systems having a large number of input devices, for example 6 or more input devices, as it minimises any lag due to the operation of such a large number of devices.

By providing a games unit, incorporating a unitary display 135, formed from a plurality of display units 5 as described above, wherein the unitary display 135 is arranged to display a bird's eye view of substantially an entire game area, and the display systems 5 combining to provide a plurality of input devices 20, a multiplayer game unit is provided that allows many players to participate whilst all viewing the same unitary, seamless display 135. Each player has a view of the entire game area and so is aware of all the information available in the game in a single view and is capable of being aware of the actions of all the other players in addition to the user's own actions. This arrangement allows players to use tactics within the game and promotes an improved game experience.

To overcome the deficiencies of the prior art, in which nowhere has a means been provided to create or edit image data on the display itself, and provide an on board solution to providing complete autonomy, i.e. providing a means to create/edit/manipulate/display image data on the one single unit, the present invention provides an intelligent display unit. To enhance the overall features of this unit it may link with other similar units to form other display arrangements if so desired. Not only arrangements which provide a single geometrical shape, but also decoupled units which may act as one, a message displaying board whose units can form any shape of stringed arrangements; circular, oval, wavy, or rectangular of so desired. Additional optional features are described in detailed in other parts of the description.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

Further modifications and improvements may be added without departing from the scope of the invention herein described. For example, whilst the embodiments described herein refer to advantageously connecting the display systems 5 together to form interconnected displays 135, it will be appreciated that the display systems 5 are also operable as individual stand alone systems, and are capable of running independently of other display systems. In addition, although the display systems 5 have been described herein in relation to a games unit and an entertainment or sign system, it will be appreciated that the systems may be used for other applications, such as machinery displays, status displays, data read-outs and the like. Further, although the input means have been described as key pads, it will be appreciated that other input means may be alternatively or additionally used, such as joysticks, gamepads, rollerballs, a mouse, a wireless controller and/or a separate keypad and that such input means may be removably connected, permanently connected or wirelessly connected. Although the system described above is described as operable as a complete unit, in alternate embodiments the system may additionally or alternatively be adapted to communicate with a computer in order to receive input and/or output and/or communications. Accordingly the above description of the specific embodiment is made by way of example only and not for the purposes of limitation. It will be clear to the skilled person that minor modifications may be made without significant changes to the operation described.

1. A self contained stand alone display device comprising:
a display for displaying at least one image;
a processor for controlling the display;
at least one memory arranged to store at least one program for execution by the processor and at least one image displayable by the display;
at least one interconnect for connecting the display device to at least one further display device to form an interconnected display; and
at least one input device;
wherein the display comprises a matrix or array of display pixels, each display pixel comprising one or more LEDs; and
wherein that the display device is operable to construct and store the at least one image and edit the content of the at least one image responsive to the input device.

2. (canceled)

3. A display device according to claim 1, wherein the at least one further display device comprises a display for displaying at least one image; a processor for controlling the further display device; at least one memory arranged to store at least one program for execution by the processor of the further display device and at least one image displayable by the display of the further display device; at least one interconnect for connecting the further display device to the display device and/or a further display device to form the interconnected display; and at least one input device; wherein that the further display device comprises a matrix or array of display pixels, each display pixel comprising one or more LEDs, and is operable to construct the at least one image and edit the content of the at least one image for the display of the display device and/or the further display device responsive to the input device of the further display.

4. A display device according to claim 1, wherein the processor of each display device is operable to communicate display data and/or functional components of a controlling program with a processor of at least one further display device via at least one interconnect.

5. A display device according to claim 1, wherein the at least one display device is disconnectably connectable to at least one further display device.

6. A display device according to claim 1, wherein two or more display devices are arranged to abut together.

7. A display device according to claim 1, two or more display devices are arranged to connect such that the interconnected display formed thereby is operable as a unitary display.

8. A display device according to claim 1, wherein each display device has a displayable area capable of displaying one or more image and the displayable area of each display device extends to at least one edge or peripheral portion of the display device and/or extend over substantially a whole surface of the display device.

9. (canceled)

10. A display device according to claim 1, wherein two or more display devices are connectable together to form a substantially seamless interconnected display.

11. A display device according to claim 1, wherein the device is adapted to provide editing of the content of at least one image on a pixel by pixel basis.

12. A display device according to claim 1, wherein the input means is adapted to select one or both of a background colour and a foreground colour of a character or image.

13. A display device according to claim 12, wherein repeated actuation of the input means permits selection of said colours by cycling through a palette of colours.

14. A display device according to claim 1, wherein the display device is operable to retrieve two or more images from the memory and/or a computer readable medium and superimpose at least part of one image onto at least one other image to create a new image.

15. (canceled)

16. A display device according to claim 1, wherein each display pixel is individually addressable.

17. A display device according to claim 1, wherein the display pixels in each row are linked by one or more row connectors and/or the display pixels in each column are linked by one or more column connectors and each display pixel is addressable by providing a signal to one or more corresponding row and/or column connectors.

18. A display device according to claim 1, wherein the input device comprises one or more keys, push buttons and/or switches.

19. A display device according to claim 1, wherein the input device comprises an interface for receiving a signal from, at least one gamepad and/or at least one joystick and/or at least one wireless controller and/or a radio, RF or IR controller and/or at least one trackball and/or at least one mouse and/or a keyboard.

20. A display device according to claim 1, wherein two or more display devices are connectable together to form selectable interconnected display area configurations.

21. A display device according to claim 1, wherein the memory comprises ROM and/or RAM and/or EEPROM and/or a computer readable medium and/or a memory card and/or a flash memory card and/or a CD or DVD ROM, or any means or device for reading or receiving input from such a computer readable medium.

22. A display device according to claim 1, wherein the processor is operable to sequentially display at least two images in order to display an animation.

23. A display device according to claim 1, wherein the display device is operable as an electronic sign and/or a games unit.

24-32. (canceled)
